(19) United States
(12) Patent Application Publication
(10) Pub. No.: US 2016/0172933 A1
(43) Pub. Date: Jun. 16, 2016

(54) ELECTRIC DC MOTOR SYSTEM

(71) Applicant: THAS LLC, Muncie, IN (US)

(72) Inventors: Adam Strouse, Ansonia, OH (US); Travis Hickey, Yorktown, IN (US)

(73) Assignee: THAS LLC, Muncie, IN (US)

(21) Appl. No.: 14/903,665

(22) PCT Filed: Jul. 8, 2014
(86) PCT No.: PCT/US2014/045776

§ 371 Date: Jan. 8, 2016

Related U.S. Application Data
(63) Continuation-in-part of application No. 13/936,221, filed on Jul. 8, 2013, now abandoned.

(51) Int. Cl. H02K 7/14; H02K 5/14; H02K 11/00; H02K 1/17; H02K 13/10

(52) U.S. Cl. CPC H02K 7/145; H02K 1/17; H02K 13/10; H02K 11/0094; H02K 5/14

(57) ABSTRACT

An electric DC motor system for a cordless powered device includes a rotor and a stator having a plurality of non-curved permanent magnets. Each of the magnets includes six substantially flat and rectangular faces. The cordless powered device may be a vacuum cleaner, power tool, garden tool, lawn tool or the like.

### FIELD OF THE INVENTION

The invention relates to electric direct current (DC) motor systems, and, more particularly, to cordless electric DC motor systems that may be used in portable devices such as vacuum cleaners and hand-controlled lawn equipment and power tools.

### BACKGROUND OF THE INVENTION

Historically, battery operated brush-type DC motors have been around and used in a variety of applications for many years, including in small vacuum cleaners. These generally consist of a stator which includes some form of permanent magnets and a rotor having a winding energized through brush contacts. However, such configurations have been criticized for being inefficient and requiring maintenance mainly due to the replacement of the brushes. This has led to the advent of motors that do not include any brushes, commonly known as “brushless” motors. However, the present invention may provide increased efficiency in brush motors, while also reducing maintenance issues.

The motor may provide high torque and efficiency while maintaining a small size and minimizing heat generation.

The term “cordless” is generally used to refer to electrical or electronic devices that are powered by a battery or a battery pack and can operate without a power cord or cable attached to a fixed electricity supply, such as an outlet, generator, or other centralized power source, thereby allowing greater mobility. The development of more powerful rechargeable batteries in recent years has allowed the production of battery-powered versions of power tools and appliances that once required a power cord, and these are distinguished by the term “cordless,” as in cordless drills, cordless saws, cordless irons, cordless vacuums and the like.

Numerous types of DC motors have been provided in the prior art in an attempt to address the shortcomings with the traditional design but each fails to address them like the present invention. For example, U.S. Pat. Nos. 4,873,463; 7,728,479; 8,324,775; U.S. Application 2013/0147311 and European Patent 106,002 are all illustrative; however, these inventions are not as suitable for the purposes of the present invention described herein.

### SUMMARY

The present invention relates to an Electric DC Motor System and method of manufacture. The Electric DC Motor System is accomplished by an improved battery management system, new stator design incorporating high permanent magnetism (HPM) magnets and a unique controller, all of which are synchronized to maximize efficiency and lower operating temperature. The method of manufacture discloses how the present invention is made.

The invention provides a battery powered electric DC motor system and method of manufacture thereof. The present invention takes advantage of a novel design for a battery powered DC motor, which also incorporates improved battery management, HPM magnets, and improved circuitry/controls, all of which increase efficiency by, among other things, eliminating wasted energy and optimizing motor and battery performance, yielding a motor that can operate, at a minimum, very close to the same length of time in which the battery might be charged (e.g., 30 minutes of charge time yields nearly 30 minutes of use at full power). The motor of the present invention, with its increased efficiency and size, provides an advancement in cordless electric motor technology. The present invention may make a variety of cordless devices and machines more practical. In particular, the present invention is uniquely suited for use in a cordless upright vacuum cleaner and other portable power tools and equipment.

In one embodiment, the present invention provides a battery operated Electric DC Motor System that features improved efficiency and reliability as a result of the novel arrangement of components noted herein. Unlike some improvements seen in the past, the present invention enables cooperation of all the components (e.g., motor, battery, and controller) in such a way that all these components work together more efficiently than heretofore achieved in the art.

The invention comprises, in one form thereof, an electric DC motor system for a cordless vacuum cleaner, including a rotor and a stator having a plurality of permanent magnets. Each of the magnets includes six substantially flat and rectangular faces.

The invention comprises, in another form thereof, an electric DC motor system, including a rotor, a stator having a plurality of permanent magnets, and a housing containing and supporting the magnets. The housing is formed of a non-magnetic material.

The invention comprises, in yet another form thereof, an electric DC motor system for a cordless vacuum cleaner, including a rotor, a stator including at least two permanent magnets disposed opposite to each other relative to an axis of the rotor, and at least two brushes. Each of the brushes is disposed at angles relative to each of the magnets of approximately between eighty-five degrees and ninety-five degrees in circumferential directions defined by the axis of the rotor.

The invention comprises, in still another form thereof, an electric DC motor system for a cordless device including a rotor and a stator including at least two permanent magnets disposed opposite to each other relative to an axis of the rotor. Each of the magnets spans less than forty-five degrees in a circumferential direction defined by the axis.

Yet other embodiments include the features described in any of the three previous paragraphs as combined with:
(i) one or more of the features described in one or more of the four previous paragraphs,
(ii) one or more of the following aspects, or
(iii) one or more of the features described in one or more of the four previous paragraphs and one or more of the following aspects:
   wherein each of the six faces is parallel to a respective other one of the six faces; wherein each of the six faces is oriented at an angle of about ninety degrees relative to each of four other ones of the faces;
   wherein a respective gap is defined between each of the magnets and the rotor in a radial direction, each said gap being approximately between 0.025 inch and 3 inches, preferably approximately between 0.035 inch and 2 inches, more preferably approximately between 0.05 inch and 0.1 inch, and, in one embodiment, about 0.078 inch;
   wherein the system includes at least one brush, an angle between at least one of the magnets and at least one of the brushes being approximately between eighty degrees and one hundred degrees in a circumferential direction defined by an axis of the rotor;
   wherein the angle is about ninety degrees;
   wherein the plurality of permanent magnets comprises two permanent magnets disposed opposite to each other relative to an axis of the rotor, the two magnets being oriented parallel to each other;
   wherein the system further includes at least one brush and a battery pack electrically coupled to the brush and configured to provide power thereto, the battery pack including at least two batteries connected to each other in parallel and at least two batteries connected to each other in series;
   wherein the housing is formed of a plastic material;
   wherein the housing is formed of a non-ferrous metal material;
   wherein the housing contains and supports at least one brush and/or at least one magnet;
   wherein the gap may be adjustable as a means of achieving a desired target motor torque and/or a desired target rotational speed of the rotor;
   wherein the system includes a battery pack electrically coupled to the brushes and configured to provide power thereto, the battery pack including at least two batteries connected to each other in parallel and at least two other batteries connected to each other in series;
   wherein the angles are each between a first centerline bisecting a corresponding brush and a second centerline bisecting a corresponding magnet;
   wherein the system includes a housing containing and supporting the magnets and the brushes, the housing being formed of a non-magnetic material;
   wherein the brushes are driven via pulse width modulation; and
   wherein the system includes a processor coupled to the brushes and configured to control the pulse width modulation.

Traditionally, upright vacuum cleaners, with their torque and storage requirements, have primarily been “corded.” However, the present invention opens the door to having a battery operated power tool, such as but not limited to an upright vacuum cleaner. The numerous advantages are, firstly, the fact that the user need not struggle with finding an outlet in which to plug the unit, and, secondly, when the unit is being used, a cordless unit avoids the troubles in dealing with the power cord, not to mention the issue of accidental unplugging of the unit, which sometimes occurs. These advantages are multiplied when considering cleaning (and/or groundskeeping) in a commercial environment, such as a hotel or commercial office setting and the reduced labor costs brought about by the present invention.

As used throughout this specification and claims, reference is made to magnets formed of one or more materials that display a “high permanent magnetism” denoted as “HPM” herein. These magnets, such as Neodymium magnets, are deemed to be those which, when compared to typical ferrite magnets as commonly known in the art, display three (3×) or more times the magnetic flux density, and three (3×) or more times the coercive force, to give approximately ten (10×) times the total energy per unit volume. Further, when the term “Electric DC Motor System” is used in this specification (including as the title of this invention), it is understand that this includes all components in which to make the invention operate, to wit: a motor, which may include a stator and rotor; a controller, which may be attached to the motor; and a battery, which may be attached to the controller. This term should not be confused with the more generic use of the term “motor,” which includes only a stator, rotor and associated hardware.

An advantage of the invention is that it may provide a high level of electromagnetic force and increased battery capacity, resulting in longer operation between battery re-charging than is known in the prior art.

### BRIEF DESCRIPTION OF THE DRAWINGS

A better understanding of the present invention will be had upon reference to the following description in conjunction with the accompanying drawings.

FIG. 1 is a schematic view of one embodiment of the motor of the present invention in a configuration for use with an upright vacuum cleaner.

FIG. 2 is a schematic, expanded, partially cross-sectional view one embodiment of the stator and commutator of the motor.

FIG. 3 is a schematic diagram of one embodiment of the motor.

FIG. 4 is a schematic circuit diagram of one embodiment of the motor.

FIG. 5 is a schematic block diagram of another embodiment of an electric DC motor system provided by the present invention.

FIG. 6 is a schematic circuit diagram of one embodiment of the motor and driver circuit of the system of FIG. 5.

FIG. 7 is a schematic circuit diagram of one embodiment of the battery pack of the system of FIG. 5.

FIG. 8 a schematic block diagram of yet another embodiment of an electric DC motor system provided by the present invention.

FIG. 9 is an exploded perspective view of one embodiment of a motor suitable for use in an electric DC motor system of the invention.

FIG. 10 is a perspective view of the motor of FIG. 9.

FIG. 11 is a side view of the motor of FIG. 9.

FIG. 12 is a schematic top view of the motor of FIG. 9.

### DETAILED DESCRIPTION OF THE PREFERRED EMBODIMENTS

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

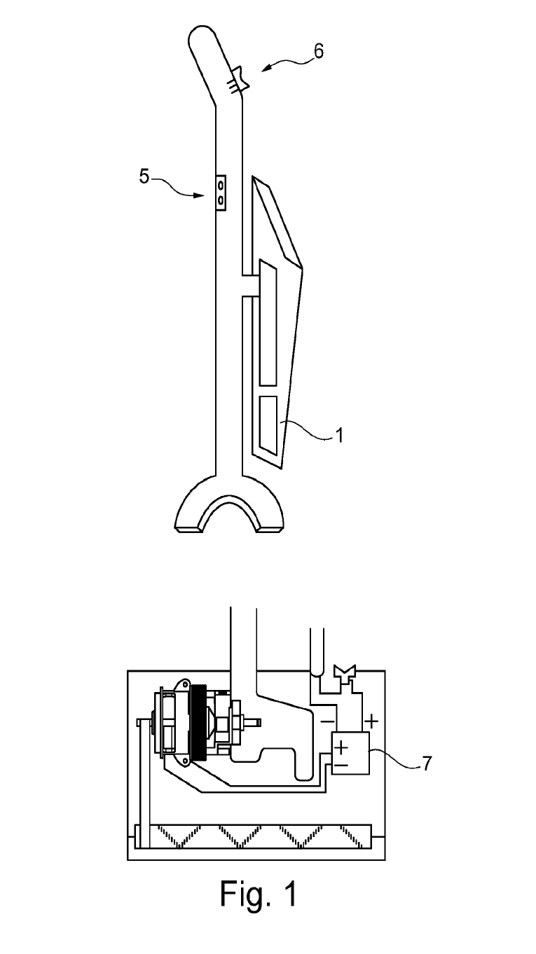

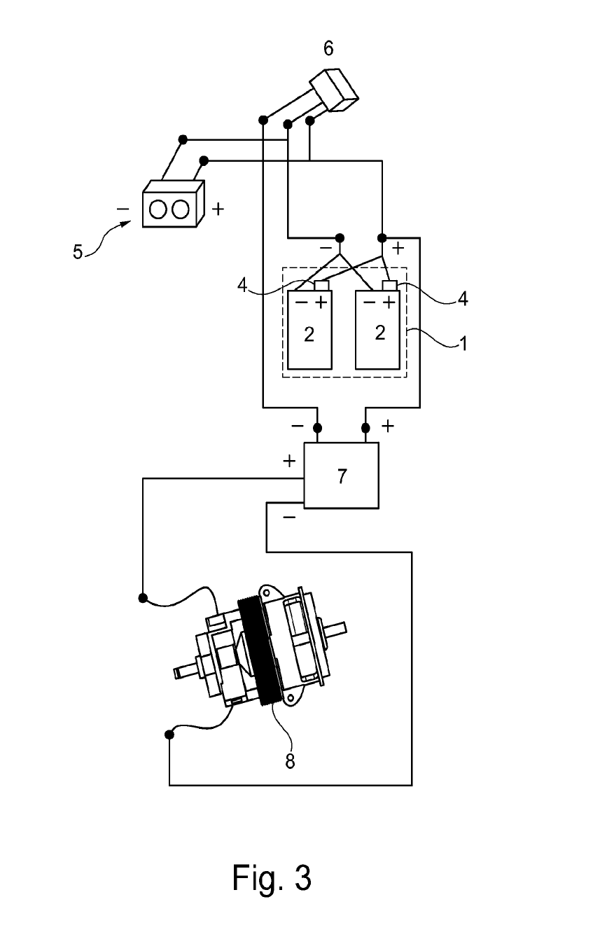

Battery system 1 (FIG. 1) may provide energy to the motor, and may be a high-capacity, high-use battery. Battery system 1 may be selected and tuned to meet the specific requirements of the motor itself in conjunction with the controller's efforts to minimize draw on the battery, while still maintaining the amount of energy needed for the motor to complete its appointed task. Battery system 1 may include multiple independent battery packs 2 (FIG. 3) each having its own circuitry 4 that limits the rate at which energy is discharged from each battery pack 2, thus limiting heat generation, and also limiting the total amount of discharge allowed from any such battery pack 2. Limiting deep discharge from a battery pack may extend the useful life of the battery pack by virtue of the pack and the associated battery chemistry never being stressed outside the normal peak operating limits. In the illustrated embodiment of FIG. 3, two battery packs 2 with associated circuitry 4 are included.

The battery may be recharged from an outside source 5 dependent upon a position of a switch 6. The switch 6 enables the device to be turned ON or OFF, or may enable the selection of a different setting of operation, e.g., high speed versus low speed. The switch 6 may be connected to a controller 7, which, in turn, is connected to the motor 8.

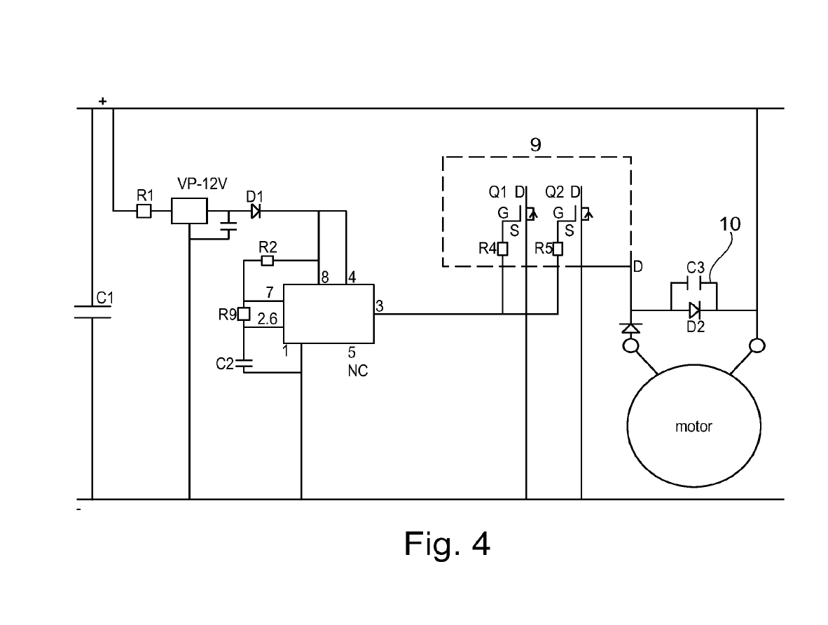

Controller 7 controls the flow of electricity from the battery to the motor and manages the energy used by the motor. Part of this management is an electrical pulse means 9 (FIG. 4). This pulse means operates intermittently and may maintain a constant speed of the rotor, sending the pulse only when the rotor needs additional rotational velocity. In this way, only the minimally required amount of energy is sent to the motor in order to drive, in a pulsating manner, the motor. Further, the controller also includes a means 10 in which to recapture energy generated by the movement of the motor, and this energy is returned to the motor, as necessary. This arrangement may therefore minimize the energy that is drawn from the battery, thus increasing battery use-time.

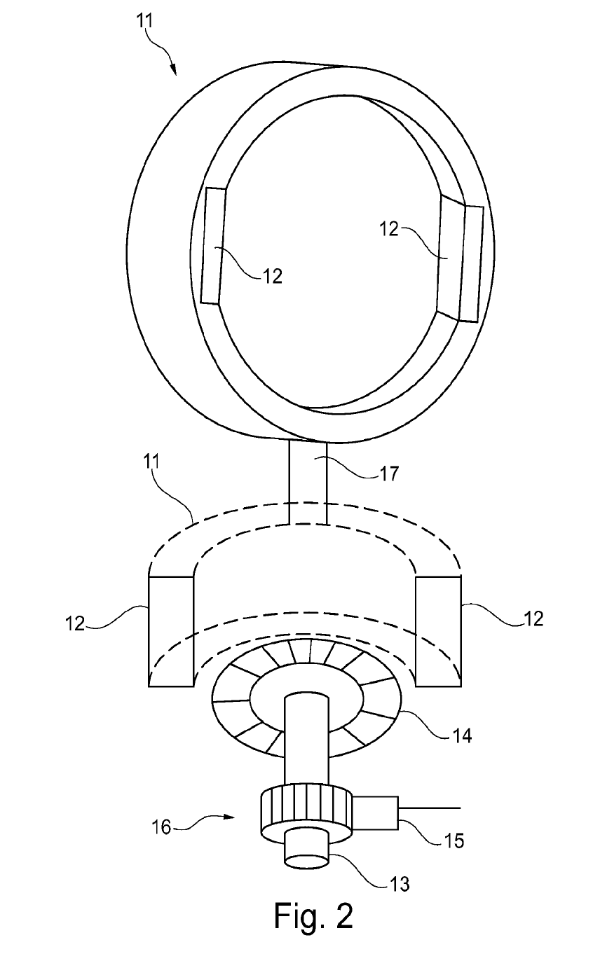

The motor may include a stator 11 (FIG. 2) having magnets 12 and a rotor 13 having a winding 14 energized through brush contacts 15 that touch a commutator 16. Unlike traditional DC motors, the motor of the present invention has a stator exterior 11 that is made of plastic versus metal. This helps reduce heat and eliminates possible distortion in the magnetic fields involved in the operation of the motor.

Also, unlike the arrangement of most magnets in a traditional DC motor, which are curved and extend around almost the entire circular interior of the stator, the present invention provides magnets arranged in a linear fashion taking up only approximately ten percent (10%) of the curved interior circumference of the stator or housing. This amount of coverage may vary depending upon the requirements of the motor, but may generally be less that the amount of coverage seen in traditionally built DC motors. Further, the magnets used are HPM magnets and in one embodiment may be neodymium in nature.

The HPM magnets may be placed in the stator in linear fashion as shown in FIG. 2. As noted above, these magnets are smaller than traditionally used and only so many are used as is necessary to facilitate continued movement of the rotor via the relationship with the windings, which are fixedly attached to the rotor and commutator. The rotor, windings and commutators all move in a circular fashion around a center point of the rotor shaft 17. In this way, the magnetic field in the stator created by the HPM magnets is tuned specifically to that created by the rotor. This results in increased efficiency as the two magnetic fields do not end up fighting against each other. In the embodiment shown in FIG. 2, the number of HPM magnets is two, and they are arranged such that they are not of curved design, to mimic the arc of a circle, but are rather linear.

The invention also includes a method of manufacturing the Electric DC Motor System. This method begins with determining the requirements of the use for the Electric DC Motor System, which includes determining the amount of torque and speed, or speeds, which would be required from the motor. Once determined, then a motor, of the type disclosed in this invention, is made using the novel elements disclosed herein, such that the motor meets the necessary requirements. Thereafter, the controller is made, as disclosed herein, in light of the requirements of motor in conjunction with the energy needs (e.g., volts and amps) necessary to meet the requirements. Next, a battery system may be selected in light of the controller and consistent with its energy needs as determined by the requirements, which may include the amount of battery packs and their respective circuitry. A method of manufacture as indicated may ensure that all three components of the Electric DC Motor System work at maximum efficiency, which may result in significantly improved operating time, as well as lower operating temperature and a minimization of wasted energy.

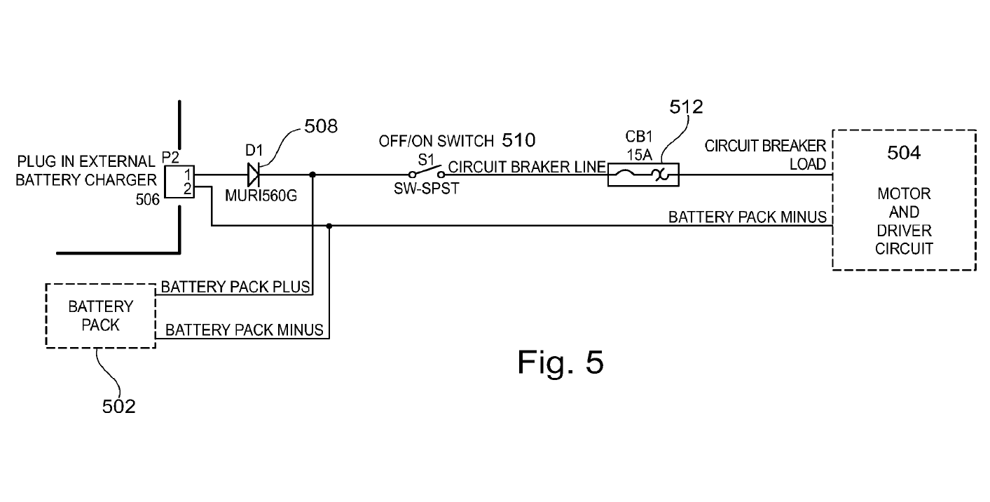

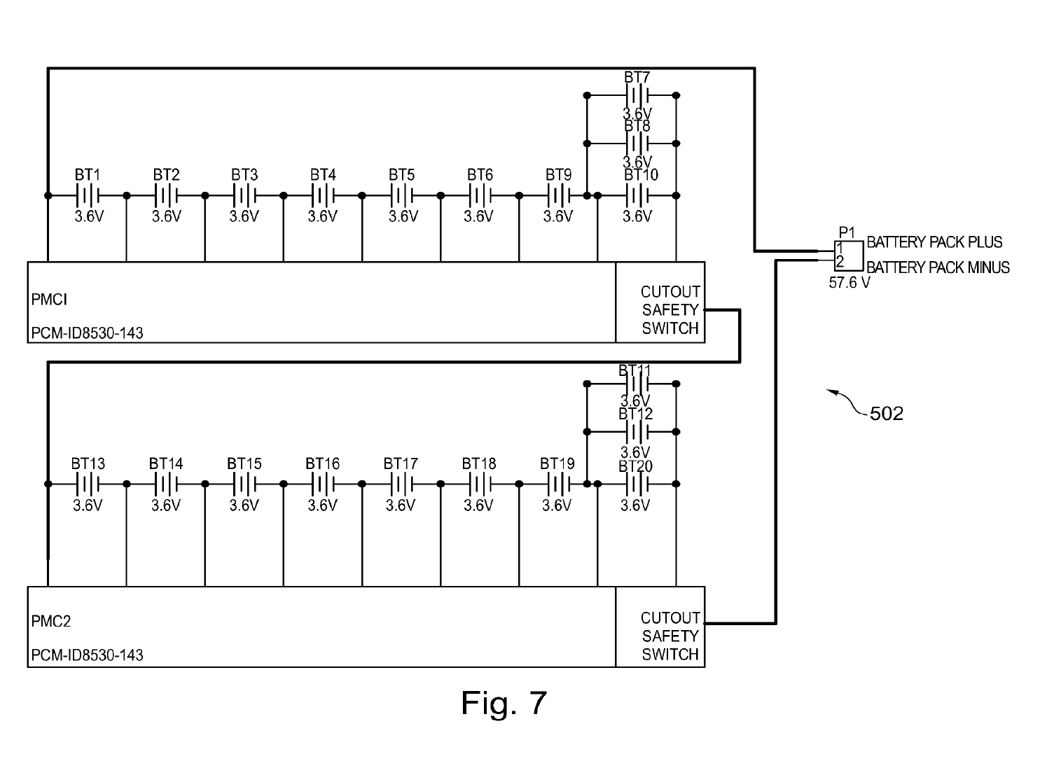

Another embodiment of an electric DC motor system of the present invention is shown in FIG. 5, including a battery pack 502, a motor and driver circuit 504, a plug-in external battery charger 506, a diode 508, an ON/OFF switch 510 and a circuit breaker 512. The detail of battery pack 502 is shown in FIG. 7, including charge controllers PMC1 and PMC2. Each of these charge controllers may be on its own dedicated circuit board. As shown, some of the batteries may be connected in series with each other, and some of the batteries may be connected in parallel with each other. Parallel combinations of batteries may be connected in series with other batteries or with other parallel combinations of batteries.

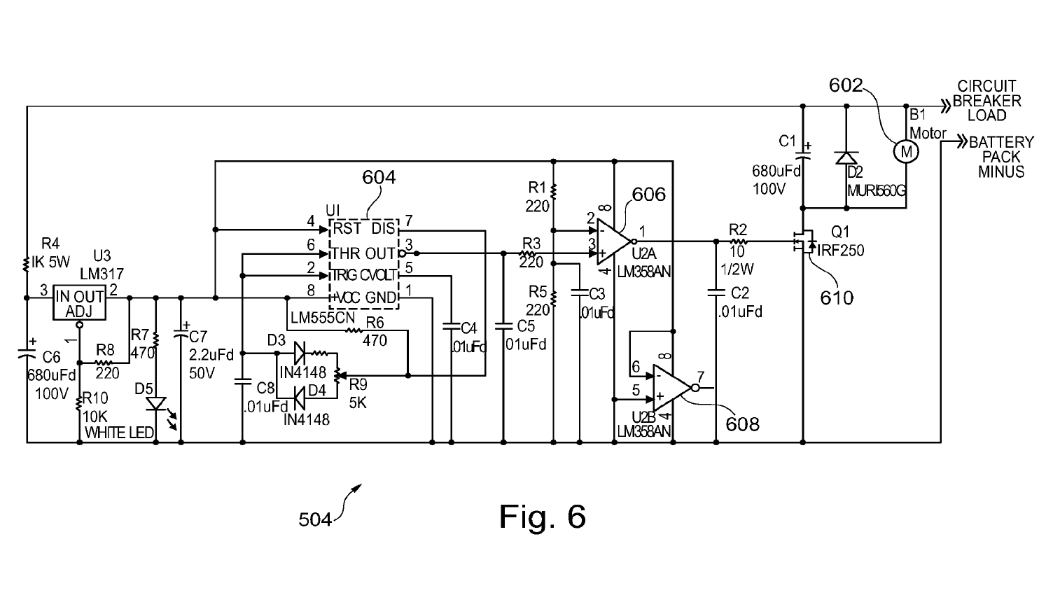

The detail of motor and driver circuit 504 is shown in FIG. 6, including a motor 602 and various electronic components including an LM555CN timer controller 604. The general function of the motor driver circuit is to limit the total current available to the motor from the battery and improve overall system efficiencies by reducing some potential losses. By eliminating the field coil of the motor and adding permanent magnets as in this embodiment, the motor's magnetic field does not require AC wall-power in order to be present. This permanent-magnet motor may function as a typical DC motor, relying on the commutation of the rotor windings to move the aiding and opposing magnetic forces that spin the rotor with respect to the fixed magnetic forces of the stator. With DC current applied to the rotor, and with the magnetic field fixed at the stator, when voltage is applied to the rotor, through the commutator, the current in the selected rotor winding may rise as the magnetic field builds in that rotor winding. Once the rotor winding has reached its peak in magnetic field generation, or the point of magnetic saturation, the current in the winding may rapidly rise and approach the limit imposed by the rotor winding resistance. Commutation may also provide some limit to the maximum current possible, but at the risk of switching during a peak current condition in the rotor winding, which creates arcs, high electrical noise and electromagnetic radiation, which can contribute to wear and reduced life for the commutator and rotor windings.

Because the rotor winding DC resistance is very low, nearly zero Ohms, the current can be extremely high and yet produce no work at the motor shaft, only converting this energy to heat. The pulse width modulation (PWM) circuit, including LM555CN timer controller 604, allows the output of the battery to be current limited by only applying DC power for 70-90% of the time, allowing the rotor-generated magnetic field to relax in the off-time, and keeping the rotor windings out of saturation. This may elevate the overall efficiency rating by reducing the potential losses of applying power to the rotor when it is potentially saturated. This percentage can be manually adjusted for best performance under nominal load conditions. It can also be improved such that the duty cycle could be made relative to commutation allowing the efficiency to remain optimized throughout motor startup, from low-speed to high-speed, and under various load conditions.

The LM555 timer controller 604 may be used to set the duty-cycle of its output as a function of the time constant created by R6, R9, and C8. The LM555 timer controller 604 may generate a constant pulse width that may serve to extend battery life. The digital output of LM555 timer 604 may be level converted by U2 operational amplifiers 606, 608 to create the appropriate switching levels for the gate of MOSFET (Q1) 610 to reach the fully-saturated on and off levels required for minimum switch losses. MOSFET Q1 (e.g., part no. IRF250) 610 may work as a sinking switch to the motor by pulling one of the motor rotor leads to BATTERY-MINUS, while the other rotor lead is permanently affixed to BATTERY-PLUS.

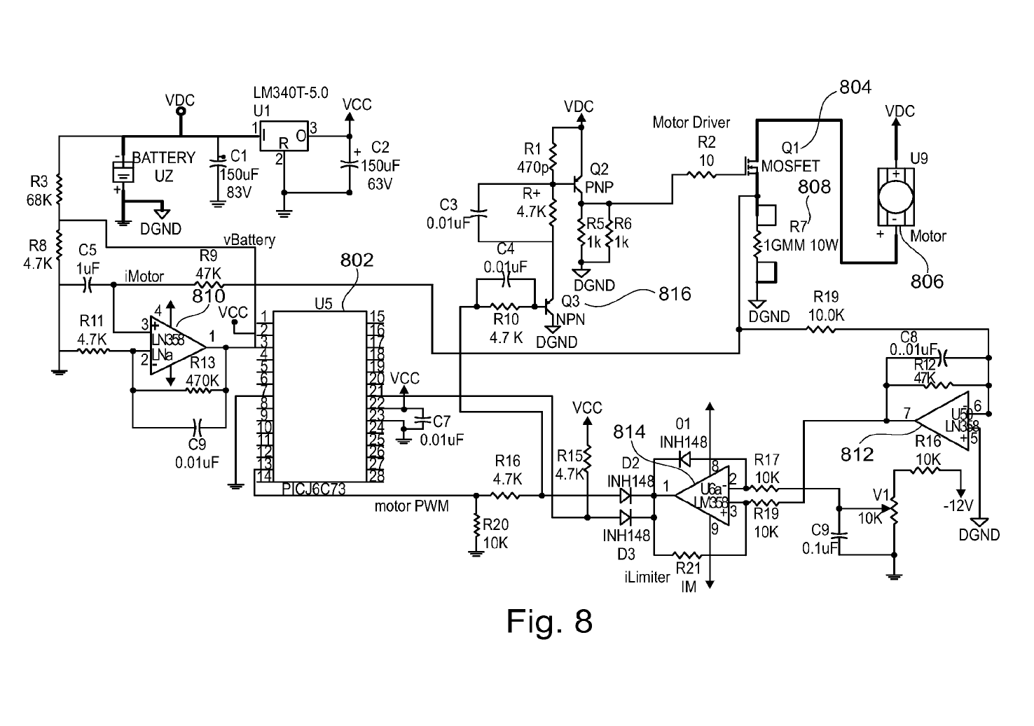

Illustrated in FIG. 8 is an embodiment of an electric DC motor system in which the PWM drive may be controlled by a microprocessor 802. In the illustrated embodiment, microprocessor is a model PIC16C73 processor marketed by Microchip Technology Inc., and its pinout is well known to those of skill in the art. The microprocessor can monitor motor current, battery voltage, and may additionally monitor battery current and motor shaft rotation to improve the application of energy to the motor in a manner that further improves efficiency.

Microprocessor 802 may use firmware to control an on-chip timer that creates a pulse-width-modulated (PWM) drive signal. This PWM signal is amplified by Q1 (MOSFET) 804 and applied to the motor 806. Current flowing through the motor windings is measured across a shunt resistance (R7) 808 and monitored by amplifiers 810, 812 and 814. Amplifiers 812, 814 provide a shutdown signal to MOSFET 804 through transistor Q3 816 as the current in the motor winding approaches a designated maximum. Similarly, an interrupt is transmitted to microprocessor 802 to signal to the microprocessor that the maximum allowed current is being reached. Microprocessor 802 also monitors the average current to the motor, which is represented as a DC level by amplifier 810.

In this diagram of FIG. 8 the battery voltage is monitored by microprocessor 802 providing an ability to shut the drive off when the battery level becomes critically low. This same signal also enables evaluation of the discharge rate of the battery over time to better manage the current delivered by the PWM and transistor 804 and achieve better run times for the system while in use.

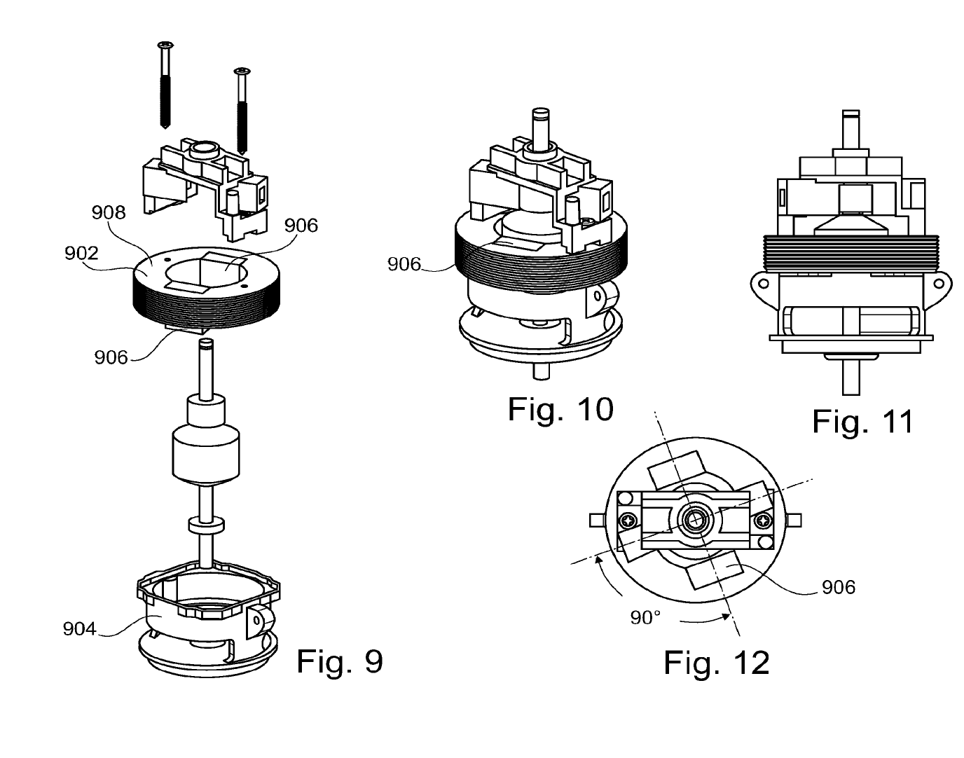

Illustrated in FIGS. 9-12 is an embodiment of a motor suitable for use in an electric DC motor system of the present invention. The motor includes brushes, permanent magnetics and a rotor. A housing or casing 902 of the magnets and/or a housing or casing 904 of the motor may be formed of non-ferrous metal or some non- metal material such as plastic. This helps reduce heat and eliminates possible distortion in the magnetic fields involved in the operation of the motor.

Magnets 906 may be linear in that they may have no curved surfaces, but instead have six rectangular, flat faces and twelve line segment edges. In the embodiment shown, each of the two magnets 906 may span less than 45 degrees of the interior circumference of the magnetics housing 908. In another embodiment, each of the two magnets 906 may span less than 30 degrees of the interior circumference of the magnetics housing 908. In yet another embodiment, each of the two magnets 906 may span approximately between 10 degrees and 30 degrees of the interior circumference of the magnetics housing 908. This relatively small circumferential span of the magnets may provide a narrower magnetic focus which allows the pulse to push past the point of magnetism and then better enable the magnets to do some pushing and pulling to better utilize their power. The result is greater efficiency and more torque in some applications. Magnets 906 may be aligned in that they are disposed opposite each other (e.g., 180 degrees apart in a circumferential direction defined by the axis of the rotor) within housing 908.

FIG. 12 illustrates a 90-degree angular difference between the center line of the permanent magnets and the center line of the brushes. However, it is to be understood that this angle may vary from 90 degrees.

A gap between the permanent magnets and the rotor is shown in FIG. 12 to be preferably about 0.078 inch. This relatively small gap may advantageously produce a high level of torque with the magnets being relatively close to the armature. However, if more torque is needed for a particular application (e.g., a cordless chain saw), then the motor's rotational speed may be sacrificed (i.e., reduced) by further reducing the gap. Conversely, if more rotor speed is needed (e.g., for a cordless vacuum cleaner), then the motor's torque may be sacrificed (i.e., reduced) by increasing the gap. Thus, this invention provides a DC motor of variable design that affords the user to custom design and manufacture a DC motor depending on its intended field of use.

Another advantage of the above-described motor configuration is that it may enable magnetism to push the rotation of the rotor through the cycles rather than electricity providing the pushing force.

Although the invention has been described herein as being implemented with linear magnets, it is to be understood that it is within the scope of the invention to use C-shaped magnets, and particularly rare earth C-shaped magnets.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An electric DC motor system for a cordless device, comprising:
a rotor; and
a stator including at least two permanent magnets disposed opposite to each other relative to an axis of the rotor, each of the magnets spanning less than forty-five degrees in a circumferential direction defined by the axis.

2. The system of claim 1 wherein a respective gap is defined between each of the magnets and the rotor in a radial direction, each said gap being approximately between 0.05 inch and 0.1 inch.

3. The system of claim 1 further comprising at least one brush, an angle between at least one of the magnets and at least one of the brushes being approximately between eighty degrees and one hundred degrees in the circumferential direction defined by an axis of the rotor.

4. The system of claim 3 wherein the angle is about ninety degrees.

5. The system of claim 1 wherein the two magnets are oriented parallel to each other, each of the magnets including six substantially flat and rectangular faces.

6. The system of claim 5 wherein each of the six faces is parallel to a respective other one of the six faces.

7. The system of claim 5 wherein each of the six faces is oriented at an angle of about ninety degrees relative to each of four other ones of the faces.

8. The system of claim 1 further comprising at least one brush and a battery pack electrically coupled to the brush and configured to provide power thereto, the battery pack including at least two batteries connected to each other in parallel and at least two batteries connected to each other in series.

9. The system of claim 1 wherein the cordless device is a vacuum cleaner.

10. The system of claim 1 wherein the cordless device is a power tool.

11. The system of claim 1 wherein the cordless device is a garden or lawn tool.

12. An electric DC motor system, comprising:
a rotor;
a stator including a plurality of permanent magnets; and
a housing containing and supporting the magnets, the housing being formed of a non-magnetic material.

13. The system of claim 12 wherein the housing is formed of a plastic material.

14. The system of claim 12 wherein the housing is formed of a non-ferrous metal material.

15. The system of claim 12 wherein the housing contains and supports at least one brush, at least one of the magnets being disposed at an angle approximately between eighty-five degrees and ninety-five degrees in a circumferential direction defined by an axis of the rotor.

16. The system of claim 12 wherein a respective gap is defined between each of the magnets and the rotor in a radial direction, each said gap being approximately between 0.05 inch and 0.1 inch.

17. The system of claim 16 wherein the gap may be adjustable as a means of achieving a desired target motor torque and/or a desired target rotational speed of the rotor.

18. An electric DC motor system for a cordless vacuum cleaner, comprising:
a rotor;
a stator including at least two permanent magnets disposed opposite to each other relative to an axis of the rotor; and
at least two brushes, each of the brushes being disposed at angles relative to each of the magnets of approximately between eighty-five degrees and ninety-five degrees in circumferential directions defined by the axis of the rotor.

19. The system of claim 18 wherein the angles are each about ninety degrees.

20. The system of claim 18 further comprising a battery pack electrically coupled to the brushes and configured to provide power thereto, the battery pack including at least two batteries connected to each other in parallel and at least two other batteries connected to each other in series.

21. The system of claim 18 wherein the angles are each between a first centerline bisecting a corresponding brush and a second centerline bisecting a corresponding magnet.

22. The system of claim 18 further comprising a housing containing and supporting the magnets and the brushes, the housing being formed of a non-magnetic material.

23. The system of claim 18 wherein the brushes are driven via pulse width modulation.

24. The system of claim 23 further comprising a processor coupled to the brushes and configured to control the pulse width modulation.
